(19) United States
(12) Patent Application Publication
(10) Pub. No.: US 2021/0399839 A1
(43) Pub. Date: Dec. 23, 2021

(54) METHOD AND COMMUNICATION DEVICE FOR HARQ TRANSMISSION

(71) Applicant: Telefonaktiebolaget LM Ericsson (publ), Stockholm (SE)

(72) Inventors: Jinhua LIU, Beijing (CN); Min WANG, Luleå (SE)

(73) Assignee: Telefonaktiebolaget LM Ericsson (publ), Stockholm (SE)

(21) Appl. No.: 17/292,758

(22) PCT Filed: Oct. 31, 2019
(86) PCT No.: PCT/CN2019/114822

§ 371 Date: May 11, 2021

(30) Foreign Application Priority Data
Nov. 12, 2018 (CN) PCT/CN2018/115053

(51) Int. Cl. H04L 1/18; H04W 72/12

(52) U.S. Cl. CPC H04L 1/1812; H04L 1/1887; H04W 72/1289

(57) ABSTRACT

The present disclosure provides a method (100) in a first communication device for Hybrid Automatic Repeat reQuest (HARQ) transmission. The method (100) includes: transmitting (110) to a second communication device a set of data transmissions each containing different data from another, using one HARQ process; and receiving (120) from the second communication device HARQ feedback information for the set of data transmissions.

### TECHNICAL FIELD

The present disclosure relates to wireless communication, and more particularly, to methods and devices for Hybrid Automatic Repeat reQuest (HARQ) transmission.

### BACKGROUND

Next generation wireless systems are expected to support a wide range of use cases with varying requirements ranging from fully mobile devices to stationary Internet of Things (IoT) or fixed wireless broadband devices. In New Radio (NR), both License Assisted Access (LAA) and standalone unlicensed operations are to be supported in the 3^{rd} Generation Partnership Project (3GPP).

For unlicensed operations, unlicensed spectrums are shared between neighboring transmitters. There are regulation policies to enable fairness and/or collision avoidance over unlicensed spectrums. For collision avoidance, a transmitter is required to perform channel assessment to determine if a channel is idle before transmission. Listen Before Talk (LBT) is used in Long Term Evolution (LTE)-LAA and will be used in NR-Unlicensed (NR-U) as well. According to the LBT mechanism, a communication device, such as a terminal device (or User Equipment (UE)) or a network device, should monitor received power over an unlicensed spectrum for a preconfigured or randomly generated time interval and determine a channel to be available if the received power is lower than a preconfigured or predefined threshold.

For fairness of channel sharing, it is required that communication peers (radio nodes) shall release the channel when their channel occupation time reaches a preconfigured or predefined maximum time interval, known as Maximum Channel Occupation Time (MCOT) in the 3GPP. The value of MCOT may be different in different countries and/or for different traffic classes.

In order to determine channel availability for starting transmission, a Category 4 (Cat. 4) LBT is performed. During the MCOT, when the role of transmitter switches between wireless communication peers, a short LBT process (e.g., of 25 μs) is performed. If the channel is determined to be idle for 25 μs, the role of transmitter can switch between the wireless communication peers. With frequent switches of the role of transmitter within the MCOT, it is very likely that the channel may be occupied by another neighboring node during the short LBT.

To enhance the channel occupation, multiple consecutive slots can be scheduled for continuous uplink or downlink data transmission until the MCOT is reached. However, the number of available HARQ processes for a UE may be smaller than the number of scheduled slots (and/or mini-slots) for the UE. In Release 15, the maximum number of HARQ processes is set to 16. For any specific UE, the number of available HARQ processes could be smaller than 16. For example, when a Sub-Carrier Spacing (SCS) of 60 kHz is configured, there can be 24 slots (i.e., 24 transmissions) within MCOT of 6 ms (assuming that the entire carrier is scheduled). Since a UE has up to 16 HARQ processes per carrier, there is no enough HARQ processes to schedule the UE for 24 continuous transmissions during the MCOT and the UE may have to be scheduled with less transmissions due to HARQ process shortage. Such shortage may get worse when multiple parallel Physical Downlink Shared Channels (PDSCHs) or Physical Uplink Shared Channels (PUSCHs) for one UE is allowed in one cell, e.g. when simultaneous PUSCH transmissions in Supplementary Uplink (SUL) and NR Uplink (NUL) carriers or parallel PDSCH or PUSCH transmissions in multiple active Band Width Parts (BWPs) or sub-bands for one UE are supported in one cell, even more HARQ processes are required in order to schedule consecutive transmissions within the MCOT. For instance, when an unlicensed channel comprises 4 unlicensed channels (20 MHz per channel), an SCS of 60 kHz is configured and one PUSCH or PDSCH transmission is scheduled in each channel, 96 HARQ processes will be required for continuous transmissions within the MCOT of 6 ms. Furthermore, for shared spectrum at even higher frequency, even wider SCS (i.e., shorter slot duration) may be configured, which means the number of HARQ processes required may also be greater than 16.

### SUMMARY

It is an object of the present disclosure to provide methods and devices for HARQ transmission, capable of solving or at least mitigating the above problem associated with the shortage of HARQ processes.

According to a first aspect of the present disclosure, a method in a first communication device for HARQ transmission is provided. The method includes: transmitting to a second communication device a set of data transmissions each containing different data from another, using one HARQ process; and receiving from the second communication device HARQ feedback information for the set of data transmissions.

In an embodiment, each of the set of data transmissions can be associated with one transmission duration and/or can be encoded at the first communication device independently of any other of the set of data transmissions.

In an embodiment, the set of data transmissions can be scheduled with one or more instances of Downlink Control Information (DCI) each indicating an HARQ process identifier (ID) of the one HARQ process.

In an embodiment, the HARQ feedback information can include a bit of Acknowledgement (ACK)/Non-Acknowledgement (NACK), indicating a result of a logic operation on a set of ACKs/NACKs indicating whether respective ones of the set of data transmissions have been successfully received.

In an embodiment, the method can further include, when the HARQ feedback information indicates a NACK: retransmitting the set of data transmissions to the second communication device in a same order as it has been transmitted in time domain and/or frequency domain.

In an embodiment, the set may be subject to a set size which can be preconfigured or derivable from a number of transmissions scheduled within maximum channel occupation time and a number of available HARQ processes.

In an embodiment, the HARQ feedback information can be based on Code Block Groups (CBGs) each containing Code Blocks (CBs) from one or more of the set of data transmissions.

In an embodiment, the set of data transmissions can be transmitted and the HARQ feedback information can be received in unlicensed frequency bands.

In an embodiment, the first communication device can be a terminal device and the second communication device can be a network device. Alternatively, the first communication device can be a network device and the second communication device can be a terminal device.

According to a second aspect of the present disclosure, a method in a first communication device for HARQ transmission is provided. The method includes: receiving from a second communication device a set of data transmissions each containing different data from another, using one HARQ process; and transmitting to the second communication device HARQ feedback information for the set of data transmissions.

In an embodiment, each of the set of data transmissions can be associated with one transmission duration.

In an embodiment, the method can further include: decoding each of the set of data transmissions independently of any other of the set of data transmissions.

In an embodiment, the set of data transmissions can be scheduled with one or more instances of DCI each indicating an HARQ process ID of the one HARQ process.

In an embodiment, the set of data transmissions can be scheduled using a semi-static downlink scheduling scheme or a configured uplink scheduling scheme.

In an embodiment, the HARQ feedback information can include a bit of ACK/NACK indicating a result of a logic operation on a set of ACKs/NACKs indicating whether respective ones of the set of data transmissions have been successfully received.

In an embodiment, the method can further include, when the HARQ feedback information indicates a NACK: receiving from the second communication device retransmissions of the set of data transmissions in a same order as it has been received in time domain and/or frequency domain; identifying retransmissions of one or more of the set of data transmissions that have not been successfully received based on the order; and soft combining the one or more data transmissions and the retransmissions thereof.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be received and the HARQ feedback information can be transmitted in unlicensed frequency bands.

In an embodiment, the first communication device can be a terminal device and the second communication device can be a network device. Alternatively, the first communication device can be a network device and the second communication device can be a terminal device.

According to a third aspect of the present disclosure, a method in a network device for facilitating HARQ transmission is provided. The method includes: transmitting to a terminal device configuration information indicating a number of HARQ process IDs to be used in transmission to or from the terminal device; and transmitting to the terminal device DCI containing a HARQ process ID field having a length dependent on the number of HARQ process IDs.

According to a fourth aspect of the present disclosure, a method in a terminal device for facilitating HARQ transmission is provided. The method includes: receiving from a network device configuration information indicating a number of HARQ process IDs to be used in transmission to or from the network device; and receiving from the network device DCI containing a HARQ process ID field having a length dependent on the number of HARQ process IDs.

According to a fifth aspect of the present disclosure, a network device is provided. The network device includes a transceiver, a processor and a memory. The memory contains instructions executable by the processor whereby the network device is operative to perform the method according to any of the first, second and third aspects.

According to a sixth aspect of the present disclosure, a computer readable storage medium is provided. The computer readable storage medium has computer program instructions stored thereon. The computer program instructions, when executed by a processor in a network device, cause the network device to perform the method according to any of the first, second and third aspects.

According to a seventh aspect of the present disclosure, a terminal device is provided. The terminal device includes a transceiver, a processor and a memory. The memory contains instructions executable by the processor whereby the terminal device is operative to perform the method according to any of the first, second and fourth aspects.

According to an eighth aspect of the present disclosure, a computer readable storage medium is provided. The computer readable storage medium has computer program instructions stored thereon. The computer program instructions, when executed by a processor in a terminal device, cause the terminal device to perform the method according to any of claims the first, second and fourth aspects.

With the embodiments of the present disclosure, more than one data transmission, each containing different data from another, can share one HARQ process. Alternatively, more HARQ processes (HARQ process IDs) can be configured for uplink or downlink transmissions. In this way, the above shortage of HARQ processes can be solved or at least mitigated.

### BRIEF DESCRIPTION OF THE DRAWINGS

The above and other objects, features and advantages will be more apparent from the following description of embodiments with reference to the figures, in which:

FIG. 1 is a flowchart illustrating a method for HARQ transmission according to an embodiment of the present disclosure;

FIG. 2 is a schematic diagram showing an example of retransmission in response to a NACK;

FIG. 3 is a flowchart illustrating a method for HARQ transmission according to another embodiment of the present disclosure;

FIG. 4 is a flowchart illustrating a method in a network device for facilitating HARQ transmission according to another embodiment of the present disclosure;

FIG. 5 is a flowchart illustrating a method in a terminal device for facilitating HARQ transmission according to another embodiment of the present disclosure;

FIG. 6 is a block diagram of a network device according to an embodiment of the present disclosure;

FIG. 7 is a block diagram of a network device according to another embodiment of the present disclosure;

FIG. 8 is a block diagram of a terminal device according to an embodiment of the present disclosure;

FIG. 9 is a block diagram of a terminal device according to another embodiment of the present disclosure;

FIG. 10 schematically illustrates a telecommunication network connected via an intermediate network to a host computer;

FIG. 11 is a generalized block diagram of a host computer communicating via a base station with a user equipment over a partially wireless connection; and

FIGS. 12 to 15 are flowcharts illustrating methods implemented in a communication system including a host computer, a base station and a user equipment.

### DETAILED DESCRIPTION

As used herein, the term “wireless communication network” refers to a network following any suitable communication standards, such as NR, LTE-Advanced (LTE-A), LTE, Wideband Code Division Multiple Access (WCDMA), High-Speed Packet Access (HSPA), and so on. Furthermore, the communications between a terminal device and a network device in the wireless communication network may be performed according to any suitable generation communication protocols, including, but not limited to, Global System for Mobile Communications (GSM), Universal Mobile Telecommunications System (UMTS), Long Term Evolution (LTE), and/or other suitable 1G (the first generation), 2G (the second generation), 2.5G, 2.75G, 3G (the third generation), 4G (the fourth generation), 4.5G, 5G (the fifth generation) communication protocols, wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards, and/or any other protocols either currently known or to be developed in the future.

The term “network device” refers to a device in a wireless communication network via which a terminal device accesses the network and receives services therefrom. The network device refers to a base station (BS), an access point (AP), or any other suitable device in the wireless communication network. The BS may be, for example, a node B (NodeB or NB), an evolved NodeB (eNodeB or eNB), or (next) generation NodeB (gNB), a Remote Radio Unit (RRU), a radio header (RH), a remote radio head (RRH), a relay, a low power node such as a femto, a pico, and so forth. Yet further examples of the network device may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network device may represent any suitable device (or group of devices) capable, configured, arranged, and/or operable to enable and/or provide a terminal device access to the wireless communication network or to provide some service to a terminal device that has accessed the wireless communication network.

The term “terminal device” refers to any end device that can access a wireless communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable device, a personal digital assistant (PDA), portable computers, desktop computer, image capture terminal devices such as digital cameras, gaming terminal devices, music storage and playback appliances, wearable terminal devices, vehicle-mounted wireless terminal devices, wireless endpoints, mobile stations, laptop-embedded equipment (LEE), laptop-mounted equipment (LME), USB dongles, smart devices, wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the wireless communication network. Instead, a UE may represent a device that is intended for sale to, or operation by, a human user but that may not initially be associated with a specific human user.

The terminal device may support device-to-device (D2D) communication, for example by implementing a 3GPP standard for sidelink communication, and may in this case be referred to as a D2D communication device.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

As used herein, a downlink, DL transmission refers to a transmission from the network device to a terminal device, and an uplink, UL transmission refers to a transmission in an opposite direction.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

A possible solution to the problem of HARQ process shortage as described above may be to aggregate transmissions across slots (and/or mini-slots) into one aggregated transmission, for which one HARQ process can be used. That is, data across multiple slots/mini-slots can be encoded and decoded jointly and treated as one data transmission. However, this may break the rule of per-slot encoding/decoding and thus increase processing complexity at both the transmitter and the receiver. Further, it may require an upper layer to prepare a larger Medium Access Control (MAC) Protocol Data Unit (PDU) than the per-slot operation, resulting in increased processing complexity at the upper layer.

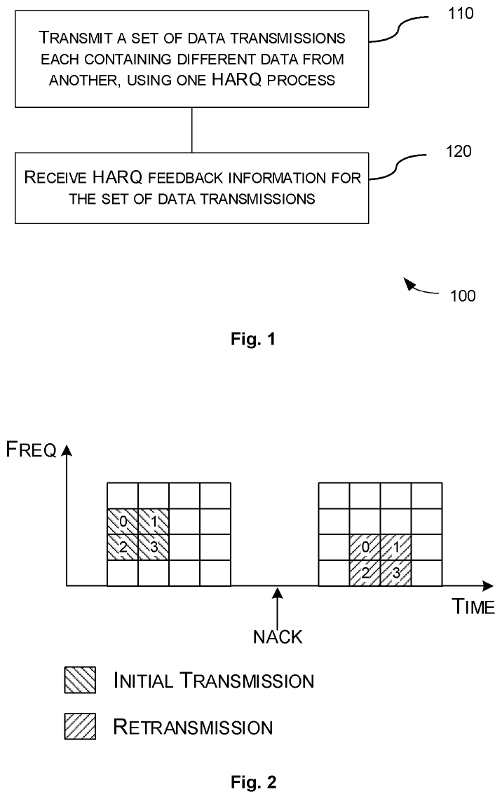

FIG. 1 is a flowchart illustrating a method 100 for HARQ transmission according to an embodiment of the present disclosure. The method 100 can be performed at a first communication device (e.g., a terminal device or a network device) in communication with a second communication device (e.g., a network device or a terminal device). The communication between the first and second communication devices may occur in unlicensed frequency bands, e.g., in NR-U or LTE LAA, or in licensed frequency bands. The communication between the first and second communication devices may also occur in shared frequency bands or licensed shared frequency bands.

At block 110, a set of data transmissions, each containing different data from another, is transmitted to the second communication device using one HARQ process. Here, each of the set of data transmissions can be associated with one transmission duration (e.g., slot or mini-slot). In an example, the set of data transmissions can be continuous in time domain and/or frequency domain. Additionally, each of the set of data transmissions can be encoded at the first communication device independently of any other of the set of data transmissions.

In an example, the set of data transmissions can be scheduled with one or more instances of DCI each indicating an HARQ process identifier ID of the one HARQ process.

At block 120, HARQ feedback information for the set of data transmissions is received from the second communication device.

In an example, the HARQ feedback information may include a bit of ACK/NACK indicating a result of a logic operation on a set of ACKs/NACKs indicating whether respective ones of the set of data transmissions have been successfully received. For example, as the HARQ feedback information, one single bit of ACK/NACK can be used to indicate a result of a logic AND operation on all ACKs/NACKs for the respective data transmissions. In this case, the HARQ feedback information indicates ACK only when all of the set of data transmissions have been successfully received.

When the HARQ feedback information indicates a NACK, the first communication device can retransmit the set of data transmissions to the second communication device in a same order as it has been transmitted in time domain and/or frequency domain. FIG. 2 shows an example of retransmission in response to a NACK. As shown, initially the first communication device transmits e.g., four Transport Blocks (TBs) #1, #2, #3 and #4 to the second communication device using one HARQ process. In response to a NACK, the first communication device retransmits the four TBs in the same order as they have been transmitted initially in time domain and frequency domain. The time-frequency positions of the TBs for the retransmission are not necessarily the same as those for the initial transmission. As long as the TBs for the initial transmission and the TBs for the retransmission are in the same order, the second communication device can apply soft combining properly. The order can be an ascending or descending order in time domain, an ascending or descending order in frequency domain, or any combination thereof. Such order can be configured via Radio Resource Control (RRC) signaling.

In an example, the set may be subject to a set size. The set size can be the maximum number of transmissions that share one single HARQ process. The set size can be preconfigured. Alternatively, the set size can be derivable from a number, N_{T}, of transmissions scheduled within maximum channel occupation time and a number, N_{H}, of available/configured HARQ processes. For example, the set size can be derived as ceiling (N_{T}/N_{H}). In an example, when six transmissions (Tx0, Tx1, . . . , Tx5) are scheduled within the MCOT and four HARQ processes (having HARQ process IDs of ID0, ID1, ID2 and ID3, respectively) are available, the set size can be preconfigured or derived as two. In this case, the HARQ process having ID0 can be used for Tx0 and Tx1, the HARQ process having ID1 can be used for Tx2 and Tx3, and the HARQ processes having ID2 and ID3 can be used for Tx4 and Tx5, respectively. Alternatively, the HARQ processes having ID0 and ID1 can be used for Tx5 and Tx4, respectively, the HARQ process having ID2 can be used for Tx3 and Tx2, and the HARQ process having ID3 can be used for Tx1 and Tx0. Given a set size, the mapping between the transmissions and the HARQ processes is not limited to the above examples and can be determined in accordance with a predefined or preconfigured mapping rule.

In an example, the HARQ feedback information can be Code Block Group (CBG)-based. In this case, each CBG may contain CBs from one or more of the set of data transmissions.

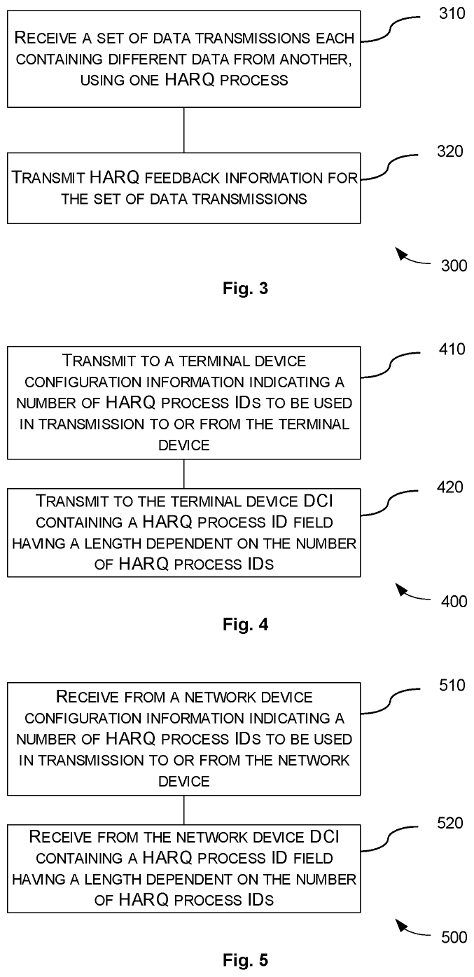

FIG. 3 is a flowchart illustrating a method 300 for HARQ transmission according to an embodiment of the present disclosure. The method 300 can be performed at a first communication device (e.g., a terminal device or a network device) in communication with a second communication device (e.g., a network device or a terminal device). The communication between the first and second communication devices may occur in unlicensed frequency bands, e.g., in NR-U or LTE LAA, or in licensed frequency bands. The communication between the first and second communication devices may also occur in shared frequency bands or licensed shared frequency bands.

At block 310, a set of data transmissions each containing different data from another is received from the second communication device using one HARQ process. Here, each of the set of data transmissions can be associated with one transmission duration (e.g., slot or mini-slot). In an example, the set of data transmissions can be continuous in time domain and/or frequency domain. In an example, the first communication device can decode each of the set of data transmissions independently of any other of the set of data transmissions

In an example, the set of data transmissions can be scheduled with one or more instances of DCI each indicating an HARQ process identifier ID of the one HARQ process. The set of data transmissions may be scheduled using a semi-static downlink scheduling scheme or a configured uplink scheduling scheme.

At block 320, HARQ feedback information for the set of data transmissions is transmitted to the second communication device.

In an example, the HARQ feedback information may include a bit of ACK/NACK indicating a result of a logic operation on a set of ACKs/NACKs indicating whether respective ones of the set of data transmissions have been successfully received. For example, as the HARQ feedback information, one single bit of ACK/NACK can be used to indicate a result of a logic AND operation on all ACKs/NACKs for the respective data transmissions. In this case, the HARQ feedback information indicates ACK only when all of the set of data transmissions have been successfully received.

When the HARQ feedback information indicates a NACK, the first communication device may then receive from the second communication device retransmissions of the set of data transmissions in a same order as it has been received in time domain and/or frequency domain. The first communication device can identify retransmissions of one or more of the set of data transmissions that have not been successfully received based on the order, and then soft combine the one or more data transmissions and the retransmissions thereof. Referring to the example shown in FIG. 2, the TBs for the initial transmission and the TBs for the retransmission are in the same order in time domain and/or frequency domain, while the time-frequency positions of the TBs for the retransmission are not necessarily the same as those for the initial transmission. Assuming in the example of FIG. 2 the first communication device has determined, e.g., by means of Cyclic Redundancy Check (CRC), that TB #0, TB #1 and TB #3 have been successfully received while TB#2 is received incorrectly, it sends a NACK to the second communication device accordingly. Upon receiving retransmission of the four TBs, the first communication device can identify the retransmission of TB #2 based on the order in time domain and frequency domain, and soft combine the initial transmission and retransmission of TB #2. In this case, the retransmission of TB #0, TB #1 and TB #3 can be simply discarded.

In an example, the set may be subject to a set size. The set size can be the maximum number of transmissions that share one single HARQ process. The set size can be preconfigured or derivable from a number of transmissions scheduled within maximum channel occupation time and a number of available HARQ processes, as discussed above in connection with the method 100.

In an example, the HARQ feedback information can be CBG-based. In this case, each CBG may contain CBs from one or more of the set of data transmissions.

FIG. 4 is a flowchart illustrating a method 400 for facilitating HARQ transmission according to another embodiment of the present disclosure. The method 400 can be performed at a network device.

At block 410, configuration information is transmitted to a terminal device. The configuration information indicates a number of HARQ process IDs to be used in transmission to or from the terminal device. The number of HARQ process IDs can be determined based on MCOT. The configuration information can be transmitted via RRC signaling.

At block 420, DCI is transmitted to the terminal device. The DCI contains a HARQ process ID field having a length dependent on the number of HARQ process IDs.

This allows the network device to configure the terminal device with sufficient number of HARQ processes to be used for data transmissions within the MCOT.

FIG. 5 is a flowchart illustrating a method 500 for facilitating HARQ transmission according to another embodiment of the present disclosure. The method 500 can be performed at a terminal device.

At block 510, configuration information is received from a network device. The configuration information indicates a number of HARQ process IDs to be used in transmission to or from the network device. The number of HARQ process IDs can be dependent on MCOT. The configuration information can be received via RRC signaling.

At block 520, DCI is received from the network device. The DCI contains a HARQ process ID field having a length dependent on the number of HARQ process IDs.

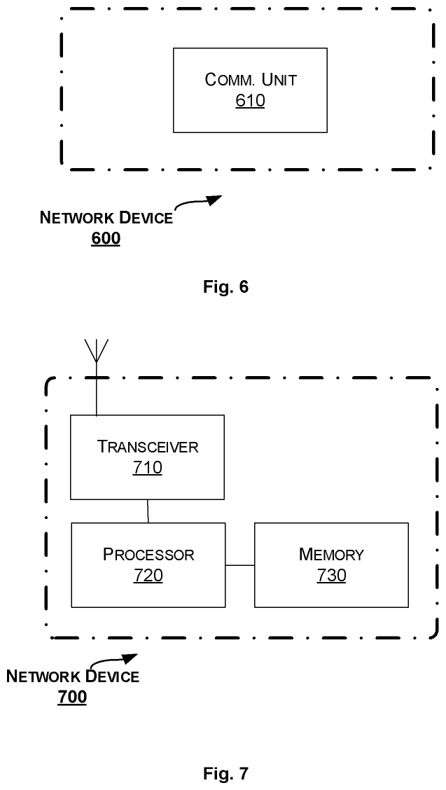

Correspondingly to the method 100, 300 and/or 400 as described above, a network device is provided. FIG. 6 is a block diagram of a network device 600 according to an embodiment of the present disclosure.

As shown in FIG. 6, the network device 600 includes a communication unit 610 configured to transmit to a terminal device a set of data transmissions each containing different data from another, using one HARQ process; and receive from the terminal device HARQ feedback information for the set of data transmissions.

In an embodiment, each of the set of data transmissions can be associated with one transmission duration and/or can be encoded at the network device independently of any other of the set of data transmissions.

In an embodiment, the set of data transmissions can be scheduled with one or more instances of DCI each indicating an HARQ process ID of the one HARQ process.

In an embodiment, the HARQ feedback information can include a bit of ACK/NACK, indicating a result of a logic operation on a set of ACKs/NACKs indicating whether respective ones of the set of data transmissions have been successfully received.

In an embodiment, the communication unit 610 can further be configured to, when the HARQ feedback information indicates a NACK: retransmit the set of data transmissions to the terminal device in a same order as it has been transmitted in time domain and/or frequency domain.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be transmitted and the HARQ feedback information can be received in unlicensed frequency bands.

Alternatively, the communication unit 610 is configured to receive from a terminal device a set of data transmissions each containing different data from another, using one HARQ process; and transmit to the terminal device HARQ feedback information for the set of data transmissions.

In an embodiment, each of the set of data transmissions can be associated with one transmission duration.

In an embodiment, the network device 600 can further include a decoding unit configured to decode each of the set of data transmissions independently of any other of the set of data transmissions.

In an embodiment, the set of data transmissions can be scheduled with one or more instances of DCI each indicating an HARQ process ID of the one HARQ process.

In an embodiment, the set of data transmissions can be scheduled using a semi-static downlink scheduling scheme or a configured uplink scheduling scheme.

In an embodiment, the HARQ feedback information can include a bit of ACK/NACK indicating a result of a logic operation on a set of ACKs/NACKs indicating whether respective ones of the set of data transmissions have been successfully received.

In an embodiment, the communication unit 610 can further be configured to, when the HARQ feedback information indicates a NACK: receive from the terminal device retransmissions of the set of data transmissions in a same order as it has been received in time domain and/or frequency domain. The decoding unit can further be configured to: identify retransmissions of one or more of the set of data transmissions that have not been successfully received based on the order; and soft combine the one or more data transmissions and the retransmissions thereof.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be received and the HARQ feedback information can be transmitted in unlicensed frequency bands.

Alternatively, the communication unit 610 is configured to transmit to a terminal device configuration information indicating a number of HARQ process IDs to be used in transmission to or from the terminal device; and transmit to the terminal device DCI containing a HARQ process ID field having a length dependent on the number of HARQ process IDs.

The unit 610 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1, 3 or 4.

FIG. 7 is a block diagram of a network device 700 according to another embodiment of the present disclosure.

The network device 700 includes a transceiver 710, a processor 720 and a memory 730. The memory 730 contains instructions executable by the processor 720 whereby the network device 700 is operative to perform the actions, e.g., of the procedure described earlier in conjunction with FIG. 1, 3 or 4.

Particularly, the memory 730 contains instructions executable by the processor 720 whereby the network device 700 is operative to: transmit to a terminal device a set of data transmissions each containing different data from another, using one HARQ process; and receive from the terminal device HARQ feedback information for the set of data transmissions.

In an embodiment, each of the set of data transmissions can be associated with one transmission duration and/or can be encoded at the network device independently of any other of the set of data transmissions.

In an embodiment, the set of data transmissions can be scheduled with one or more instances of DCI each indicating an HARQ process ID of the one HARQ process.

In an embodiment, the HARQ feedback information can include a bit of ACK/NACK, indicating a result of a logic operation on a set of ACKs/NACKs indicating whether respective ones of the set of data transmissions have been successfully received.

In an embodiment, the memory 730 can further contain instructions executable by the processor 720 whereby the network device 700 is operative to, when the HARQ feedback information indicates a NACK: retransmit the set of data transmissions to the terminal device in a same order as it has been transmitted in time domain and/or frequency domain.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be transmitted and the HARQ feedback information can be received in unlicensed frequency bands.

Alternatively, the memory 730 contains instructions executable by the processor 720 whereby the network device 700 is operative to: receive from a terminal device a set of data transmissions each containing different data from another, using one HARQ process; and transmit to the terminal device HARQ feedback information for the set of data transmissions.

In an embodiment, each of the set of data transmissions can be associated with one transmission duration.

In an embodiment, the memory 730 can further contain instructions executable by the processor 720 whereby the network device 700 is operative to: decode each of the set of data transmissions independently of any other of the set of data transmissions.

In an embodiment, the set of data transmissions can be scheduled with one or more instances of DCI each indicating an HARQ process ID of the one HARQ process.

In an embodiment, the set of data transmissions can be scheduled using a semi-static downlink scheduling scheme or a configured uplink scheduling scheme.

In an embodiment, the HARQ feedback information can include a bit of ACK/NACK indicating a result of a logic operation on a set of ACKs/NACKs indicating whether respective ones of the set of data transmissions have been successfully received.

In an embodiment, the memory 730 can further contain instructions executable by the processor 720 whereby the network device 700 is operative to, when the HARQ feedback information indicates a NACK: receive from the terminal device retransmissions of the set of data transmissions in a same order as it has been received in time domain and/or frequency domain; identify retransmissions of one or more of the set of data transmissions that have not been successfully received based on the order; and soft combine the one or more data transmissions and the retransmissions thereof.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be received and the HARQ feedback information can be transmitted in unlicensed frequency bands.

Alternatively, the memory 730 contains instructions executable by the processor 720 whereby the network device 700 is operative to: transmit to a terminal device configuration information indicating a number of HARQ process IDs to be used in transmission to or from the terminal device; and transmit to the terminal device DCI containing a HARQ process ID field having a length dependent on the number of HARQ process IDs.

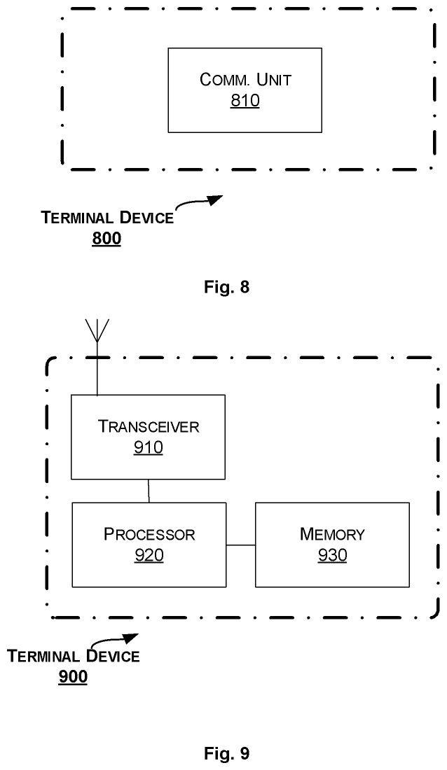

Correspondingly to the method 100, 300 and/or 500 as described above, a network device is provided. FIG. 8 is a block diagram of a terminal device 800 according to an embodiment of the present disclosure.

As shown in FIG. 8, the terminal device 800 includes a communication unit 810 configured to transmit to a network device a set of data transmissions each containing different data from another, using one HARQ process; and receive from the network device HARQ feedback information for the set of data transmissions.

In an embodiment, each of the set of data transmissions can be associated with one transmission duration and/or can be encoded at the terminal device independently of any other of the set of data transmissions.

In an embodiment, the set of data transmissions can be scheduled with one or more instances of DCI each indicating an HARQ process ID of the one HARQ process.

In an embodiment, the HARQ feedback information can include a bit of ACK/NACK, indicating a result of a logic operation on a set of ACKs/NACKs indicating whether respective ones of the set of data transmissions have been successfully received.

In an embodiment, the communication unit 810 can further be configured to, when the HARQ feedback information indicates a NACK: retransmit the set of data transmissions to the network device in a same order as it has been transmitted in time domain and/or frequency domain.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be transmitted and the HARQ feedback information can be received in unlicensed frequency bands.

Alternatively, the communication unit 810 is configured to receive from a network device a set of data transmissions each containing different data from another, using one HARQ process; and transmit to the network device HARQ feedback information for the set of data transmissions.

In an embodiment, each of the set of data transmissions can be associated with one transmission duration.

In an embodiment, the terminal device 800 can further include a decoding unit configured to decode each of the set of data transmissions independently of any other of the set of data transmissions.

In an embodiment, the set of data transmissions can be scheduled with one or more instances of DCI each indicating an HARQ process ID of the one HARQ process.

In an embodiment, the set of data transmissions can be scheduled using a semi-static downlink scheduling scheme or a configured uplink scheduling scheme.

In an embodiment, the HARQ feedback information can include a bit of ACK/NACK indicating a result of a logic operation on a set of ACKs/NACKs indicating whether respective ones of the set of data transmissions have been successfully received.

In an embodiment, the communication unit 810 can further be configured to, when the HARQ feedback information indicates a NACK: receive from the network device retransmissions of the set of data transmissions in a same order as it has been received in time domain and/or frequency domain. The decoding unit can further be configured to: identify retransmissions of one or more of the set of data transmissions that have not been successfully received based on the order; and soft combine the one or more data transmissions and the retransmissions thereof.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be received and the HARQ feedback information can be transmitted in unlicensed frequency bands.

Alternatively, the communication unit 810 is configured to receive from a network device configuration information indicating a number of HARQ process IDs to be used in transmission to or from the network device; and receive from the network device DCI containing a HARQ process ID field having a length dependent on the number of HARQ process IDs.

The unit 810 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 1, 3 or 5.

FIG. 9 is a block diagram of a terminal device 900 according to another embodiment of the present disclosure.

The terminal device 900 includes a transceiver 910, a processor 920 and a memory 930. The memory 930 contains instructions executable by the processor 920 whereby the terminal device 900 is operative to perform the actions, e.g., of the procedure described earlier in conjunction with FIG. 1, 3 or 5.

Particularly, the memory 930 contains instructions executable by the processor 920 whereby the terminal device 900 is operative to: transmit to a network device a set of data transmissions each containing different data from another, using one HARQ process; and receive from the network device HARQ feedback information for the set of data transmissions.

In an embodiment, each of the set of data transmissions can be associated with one transmission duration and/or can be encoded at the terminal device independently of any other of the set of data transmissions.

In an embodiment, the set of data transmissions can be scheduled with one or more instances of DCI each indicating an HARQ process ID of the one HARQ process.

In an embodiment, the HARQ feedback information can include a bit of ACK/NACK, indicating a result of a logic operation on a set of ACKs/NACKs indicating whether respective ones of the set of data transmissions have been successfully received.

In an embodiment, the memory 930 can further contain instructions executable by the processor 920 whereby the terminal device 900 is operative to, when the HARQ feedback information indicates a NACK: retransmit the set of data transmissions to the network device in a same order as it has been transmitted in time domain and/or frequency domain.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be transmitted and the HARQ feedback information can be received in unlicensed frequency bands.

Alternatively, the memory 930 contains instructions executable by the processor 920 whereby the terminal device 900 is operative to: receive from a network device a set of data transmissions each containing different data from another, using one HARQ process; and transmit to the network device HARQ feedback information for the set of data transmissions.

In an embodiment, each of the set of data transmissions can be associated with one transmission duration.

In an embodiment, the memory 930 can further contain instructions executable by the processor 920 whereby the terminal device 900 is operative to: decode each of the set of data transmissions independently of any other of the set of data transmissions.

In an embodiment, the set of data transmissions can be scheduled with one or more instances of DCI each indicating an HARQ process ID of the one HARQ process.

In an embodiment, the set of data transmissions can be scheduled using a semi-static downlink scheduling scheme or a configured uplink scheduling scheme.

In an embodiment, the HARQ feedback information can include a bit of ACK/NACK indicating a result of a logic operation on a set of ACKs/NACKs indicating whether respective ones of the set of data transmissions have been successfully received.

In an embodiment, the memory 930 can contain instructions executable by the processor 920 whereby the terminal device 900 is operative to, when the HARQ feedback information indicates a NACK: receive from the network device retransmissions of the set of data transmissions in a same order as it has been received in time domain and/or frequency domain; identify retransmissions of one or more of the set of data transmissions that have not been successfully received based on the order; and soft combine the one or more data transmissions and the retransmissions thereof.

In an embodiment, the set may be subject to a set size which can be preconfigured or derivable from a number of transmissions scheduled within maximum channel occupation time and a number of available HARQ processes.

In an embodiment, the HARQ feedback information can be based on CBGs each containing CBs from one or more of the set of data transmissions.

In an embodiment, the set of data transmissions can be received and the HARQ feedback information can be transmitted in unlicensed frequency bands.

Alternatively, the memory 930 contains instructions executable by the processor 920 whereby the terminal device 900 is operative to: receive from a network device configuration information indicating a number of HARQ process IDs to be used in transmission to or from the network device; and receive from the network device DCI containing a HARQ process ID field having a length dependent on the number of HARQ process IDs.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 720 causes the network device 700 to perform the actions, e.g., of the procedure described earlier in conjunction with FIG. 1, 3 or 4; or code/computer readable instructions, which when executed by the processor 920 causes the terminal device 900 to perform the actions, e.g., of the procedure described earlier in conjunction with FIG. 1, 3 or 5.

The computer program product may be configured as a computer program code structured in computer program modules. The computer program modules could essentially perform the actions of the flow illustrated in FIG. 1, 3, 4 or 5.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

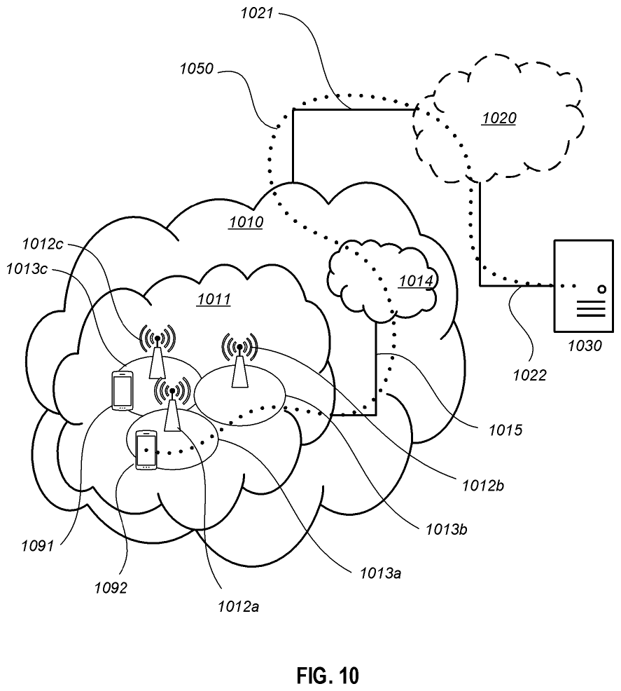

With reference to FIG. 10, in accordance with an embodiment, a communication system includes a telecommunication network 1010, such as a 3GPP-type cellular network, which comprises an access network 1011, such as a radio access network, and a core network 1014. The access network 1011 comprises a plurality of base stations 1012a, 1012b, 1012c, such as NBs, eNBs, gNBs or other types of wireless access points, each defining a corresponding coverage area 1013a, 1013b, 1013c. Each base station 1012a, 1012b, 1012c is connectable to the core network 1014 over a wired or wireless connection 1015. A first user equipment (UE) 1091 located in coverage area 1013c is configured to wirelessly connect to, or be paged by, the corresponding base station 1012c. A second UE 1092 in coverage area 1013a is wirelessly connectable to the corresponding base station 1012a. While a plurality of UEs 1091, 1092 are illustrated in this example, the disclosed embodiments are equally applicable to a situation where a sole UE is in the coverage area or where a sole UE is connecting to the corresponding base station 1012.

The telecommunication network 1010 is itself connected to a host computer 1030, which may be embodied in the hardware and/or software of a standalone server, a cloud-implemented server, a distributed server or as processing resources in a server farm. The host computer 1030 may be under the ownership or control of a service provider, or may be operated by the service provider or on behalf of the service provider. The connections 1021, 1022 between the telecommunication network 1010 and the host computer 1030 may extend directly from the core network 1014 to the host computer 1030 or may go via an optional intermediate network 1020. The intermediate network 1020 may be one of, or a combination of more than one of, a public, private or hosted network; the intermediate network 1020, if any, may be a backbone network or the Internet; in particular, the intermediate network 1020 may comprise two or more sub-networks (not shown).

The communication system of FIG. 10 as a whole enables connectivity between one of the connected UEs 1091, 1092 and the host computer 1030. The connectivity may be described as an over-the-top (OTT) connection 1050. The host computer 1030 and the connected UEs 1091, 1092 are configured to communicate data and/or signaling via the OTT connection 1050, using the access network 1011, the core network 1014, any intermediate network 1020 and possible further infrastructure (not shown) as intermediaries. The OTT connection 1050 may be transparent in the sense that the participating communication devices through which the OTT connection 1050 passes are unaware of routing of uplink and downlink communications. For example, a base station 1012 may not or need not be informed about the past routing of an incoming downlink communication with data originating from a host computer 1030 to be forwarded (e.g., handed over) to a connected UE 1091. Similarly, the base station 1012 need not be aware of the future routing of an outgoing uplink communication originating from the UE 1091 towards the host computer 1030.

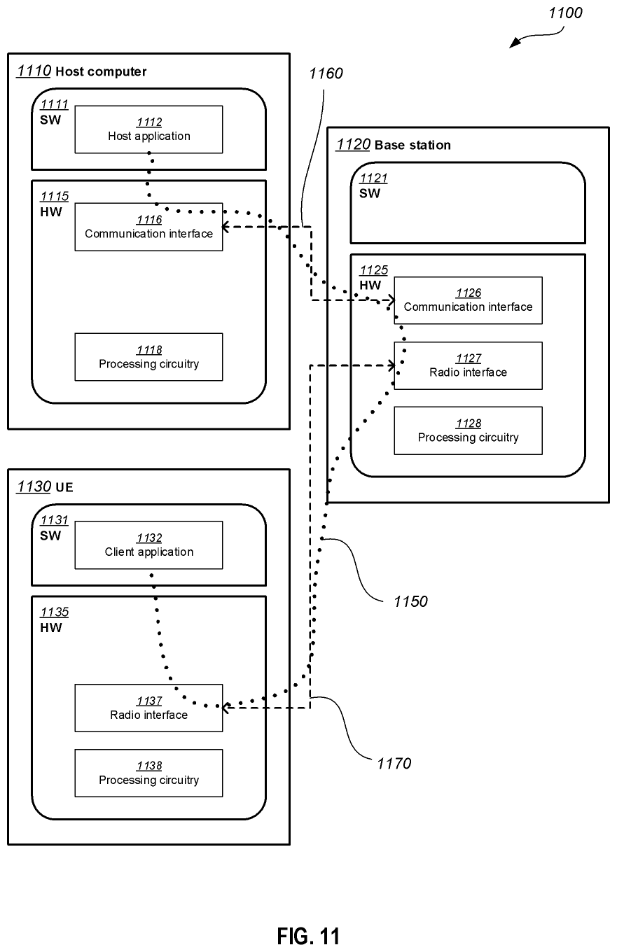

Example implementations, in accordance with an embodiment, of the UE, base station and host computer discussed in the preceding paragraphs will now be described with reference to FIG. 11. In a communication system 1100, a host computer 1110 comprises hardware 1115 including a communication interface 1116 configured to set up and maintain a wired or wireless connection with an interface of a different communication device of the communication system 1100. The host computer 1110 further comprises processing circuitry 1118, which may have storage and/or processing capabilities. In particular, the processing circuitry 1118 may comprise one or more programmable processors, application-specific integrated circuits, field programmable gate arrays or combinations of these (not shown) adapted to execute instructions. The host computer 1110 further comprises software 1111, which is stored in or accessible by the host computer 1110 and executable by the processing circuitry 1118. The software 1111 includes a host application 1112. The host application 1112 may be operable to provide a service to a remote user, such as a UE 1130 connecting via an OTT connection 1150 terminating at the UE 1130 and the host computer 1110. In providing the service to the remote user, the host application 1112 may provide user data which is transmitted using the OTT connection 1150.

The communication system 1100 further includes a base station 1120 provided in a telecommunication system and comprising hardware 1125 enabling it to communicate with the host computer 1110 and with the UE 1130. The hardware 1125 may include a communication interface 1126 for setting up and maintaining a wired or wireless connection with an interface of a different communication device of the communication system 1100, as well as a radio interface 1127 for setting up and maintaining at least a wireless connection 1170 with a UE 1130 located in a coverage area (not shown in FIG. 11) served by the base station 1120. The communication interface 1126 may be configured to facilitate a connection 1160 to the host computer 1110. The connection 1160 may be direct or it may pass through a core network (not shown in FIG. 11) of the telecommunication system and/or through one or more intermediate networks outside the telecommunication system. In the embodiment shown, the hardware 1125 of the base station 1120 further includes processing circuitry 1128, which may comprise one or more programmable processors, application-specific integrated circuits, field programmable gate arrays or combinations of these (not shown) adapted to execute instructions. The base station 1120 further has software 1121 stored internally or accessible via an external connection.

The communication system 1100 further includes the UE 1130 already referred to. Its hardware 1135 may include a radio interface 1137 configured to set up and maintain a wireless connection 1170 with a base station serving a coverage area in which the UE 1130 is currently located. The hardware 1135 of the UE 1130 further includes processing circuitry 1138, which may comprise one or more programmable processors, application-specific integrated circuits, field programmable gate arrays or combinations of these (not shown) adapted to execute instructions. The UE 1130 further comprises software 1131, which is stored in or accessible by the UE 1130 and executable by the processing circuitry 1138. The software 1131 includes a client application 1132. The client application 1132 may be operable to provide a service to a human or non-human user via the UE 1130, with the support of the host computer 1110. In the host computer 1110, an executing host application 1112 may communicate with the executing client application 1132 via the OTT connection 1150 terminating at the UE 1130 and the host computer 1110. In providing the service to the user, the client application 1132 may receive request data from the host application 1112 and provide user data in response to the request data. The OTT connection 1150 may transfer both the request data and the user data. The client application 1132 may interact with the user to generate the user data that it provides.

It is noted that the host computer 1110, base station 1120 and UE 1130 illustrated in FIG. 11 may be identical to the host computer 1030, one of the base stations 1012a, 1012b, 1012c and one of the UEs 1091, 1092 of FIG. 10, respectively. This is to say, the inner workings of these entities may be as shown in FIG. 11 and independently, the surrounding network topology may be that of FIG. 10.

In FIG. 11, the OTT connection 1150 has been drawn abstractly to illustrate the communication between the host computer 1110 and the use equipment 1130 via the base station 1120, without explicit reference to any intermediary devices and the precise routing of messages via these devices. Network infrastructure may determine the routing, which it may be configured to hide from the UE 1130 or from the service provider operating the host computer 1110, or both. While the OTT connection 1150 is active, the network infrastructure may further take decisions by which it dynamically changes the routing (e.g., on the basis of load balancing consideration or reconfiguration of the network).

The wireless connection 1170 between the UE 1130 and the base station 1120 is in accordance with the teachings of the embodiments described throughout this disclosure. One or more of the various embodiments improve the performance of OTT services provided to the UE 1130 using the OTT connection 1150, in which the wireless connection 1170 forms the last segment. More precisely, the teachings of these embodiments may improve the radio resource utilization and thereby provide benefits such as reduced user waiting time.

A measurement procedure may be provided for the purpose of monitoring data rate, latency and other factors on which the one or more embodiments improve.

There may further be an optional network functionality for reconfiguring the OTT connection 1150 between the host computer 1110 and UE 1130, in response to variations in the measurement results. The measurement procedure and/or the network functionality for reconfiguring the OTT connection 1150 may be implemented in the software 1111 of the host computer 1110 or in the software 1131 of the UE 1130, or both. In embodiments, sensors (not shown) may be deployed in or in association with communication devices through which the OTT connection 1150 passes; the sensors may participate in the measurement procedure by supplying values of the monitored quantities exemplified above, or supplying values of other physical quantities from which software 1111, 1131 may compute or estimate the monitored quantities. The reconfiguring of the OTT connection 1150 may include message format, retransmission settings, preferred routing etc.; the reconfiguring need not affect the base station 1120, and it may be unknown or imperceptible to the base station 1120. Such procedures and functionalities may be known and practiced in the art. In certain embodiments, measurements may involve proprietary UE signaling facilitating the host computer's 1111 measurements of throughput, propagation times, latency and the like. The measurements may be implemented in that the software 1111, 1131 causes messages to be transmitted, in particular empty or ‘dummy’ messages, using the OTT connection 1150 while it monitors propagation times, errors etc.

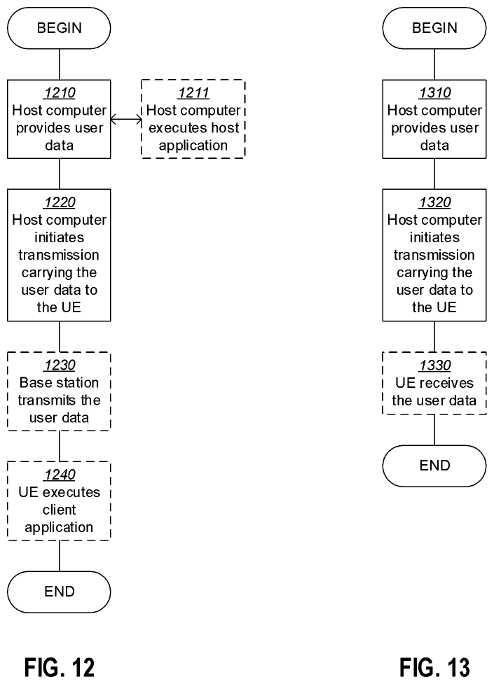

FIG. 12 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 12 will be included in this section. In a first step 1210 of the method, the host computer provides user data. In an optional substep 1211 of the first step 1210, the host computer provides the user data by executing a host application. In a second step 1220, the host computer initiates a transmission carrying the user data to the UE. In an optional third step 1230, the base station transmits to the UE the user data which was carried in the transmission that the host computer initiated, in accordance with the teachings of the embodiments described throughout this disclosure. In an optional fourth step 1240, the UE executes a client application associated with the host application executed by the host computer.

FIG. 13 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 13 will be included in this section. In a first step 1310 of the method, the host computer provides user data. In an optional substep (not shown) the host computer provides the user data by executing a host application. In a second step 1320, the host computer initiates a transmission carrying the user data to the UE. The transmission may pass via the base station, in accordance with the teachings of the embodiments described throughout this disclosure. In an optional third step 1330, the UE receives the user data carried in the transmission.

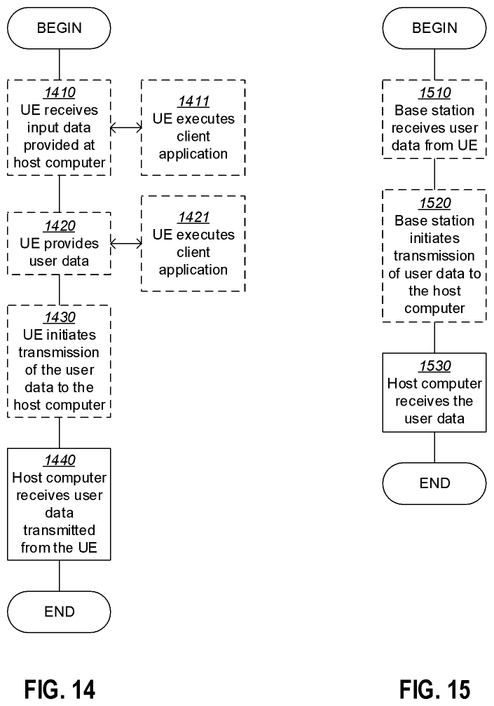

FIG. 14 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 14 will be included in this section. In an optional first step 1410 of the method, the UE receives input data provided by the host computer. Additionally or alternatively, in an optional second step 1420, the UE provides user data. In an optional substep 1421 of the second step 1420, the UE provides the user data by executing a client application. In a further optional substep 1411 of the first step 1410, the UE executes a client application which provides the user data in reaction to the received input data provided by the host computer. In providing the user data, the executed client application may further consider user input received from the user. Regardless of the specific manner in which the user data was provided, the UE initiates, in an optional third substep 1430, transmission of the user data to the host computer. In a fourth step 1440 of the method, the host computer receives the user data transmitted from the UE, in accordance with the teachings of the embodiments described throughout this disclosure.

FIG. 15 is a flowchart illustrating a method implemented in a communication system, in accordance with one embodiment. The communication system includes a host computer, a base station and a UE which may be those described with reference to FIGS. 10 and 11. For simplicity of the present disclosure, only drawing references to FIG. 15 will be included in this section. In an optional first step 1510 of the method, in accordance with the teachings of the embodiments described throughout this disclosure, the base station receives user data from the UE. In an optional second step 1520, the base station initiates transmission of the received user data to the host computer. In a third step 1530, the host computer receives the user data carried in the transmission initiated by the base station.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

1. A method in a first communication device for Hybrid Automatic Repeat reQuest (HARQ) transmission, comprising:
transmitting to a second communication device a set of data transmissions each containing different data from another, using one HARQ process; and
receiving from the second communication device HARQ feedback information for the set of data transmissions.

2. The method of claim 1, wherein each of the set of data transmissions is associated with one transmission duration and/or is encoded at the first communication device independently of any other of the set of data transmissions.

3. The method of claim 1, wherein the set of data transmissions is scheduled with one or more instances of Downlink Control Information, DCI, each indicating an HARQ process identifier, ID, of the one HARQ process.

4. The method of claim 1, wherein the HARQ feedback information comprises an acknowledgement bit indicating a result of a logic operation on a set of positive acknowledgements (ACKs) and/or negative acknowledgements (NACKs) indicating whether respective ones of the set of data transmissions have been successfully received.

5. The method of claim 4, further comprising, when the HARQ feedback information indicates a NACK:
retransmitting the set of data transmissions to the second communication device in a same order as it has been transmitted in time domain and/or frequency domain.

6. The method claim 1, wherein the set is subject to a set size which is preconfigured or derivable from a number of transmissions scheduled within maximum channel occupation time and a number of available HARQ processes.

7. The method of claim 1, wherein the HARQ feedback information is based on Code Block Groups each containing Code Blocks from one or more of the set of data transmissions.

8. The method of claim 1, wherein the set of data transmissions is transmitted and the HARQ feedback information is received in unlicensed frequency bands.

9. The method of claim 1, wherein
the first communication device is a terminal device and the second communication device is a network device, or
the first communication device is a network device and the second communication device is a terminal device.

10. A method in a first communication device for Hybrid Automatic Repeat reQuest (HARQ) transmission, comprising:
receiving from a second communication device a set of data transmissions each containing different data from another, using one HARQ process; and
transmitting to the second communication device HARQ feedback information for the set of data transmissions.

11. The method of claim 10, wherein each of the set of data transmissions is associated with one transmission duration.

12. The method of claim 10, further comprising:
decoding each of the set of data transmissions independently of any other of the set of data transmissions.

13. The method of claim 10, wherein the set of data transmissions is scheduled with one or more instances of Downlink Control Information each indicating an HARQ process identifier of the one HARQ process.

14. The method of claim 13, wherein the set of data transmissions is scheduled using a semi-static downlink scheduling scheme or a configured uplink scheduling scheme.

15. The method of claim 11, wherein the HARQ feedback information comprises an acknowledgement bit indicating a result of a logic operation on a set of positive acknowledgements (ACKs) and/or negative acknowledgements (NACKs) indicating whether respective ones of the set of data transmissions have been successfully received.

16. The method of claim 15, further comprising, when the HARQ feedback information indicates a NACK:
receiving from the second communication device retransmissions of the set of data transmissions in a same order as it has been received in time domain and/or frequency domain;
identifying retransmissions of one or more of the set of data transmissions that have not been successfully received based on the order; and
soft combining the one or more data transmissions and the retransmissions thereof.

17. The method of claim 10, wherein the set is subject to a set size which is preconfigured or derivable from a number of transmissions scheduled within maximum channel occupation time and a number of available HARQ processes.

18. The method of claim 10, wherein the HARQ feedback information is based on Code Block Groups each containing Code Blocks from one or more of the set of data transmissions.

19. The method of claim 10, wherein the set of data transmissions is received and the HARQ feedback information is transmitted in unlicensed frequency bands.

20. (canceled)

21. (canceled)

22. A method (500) in a terminal device for facilitating Hybrid Automatic Repeat reQuest (HARQ) transmission, comprising:
receiving from a network device configuration information indicating a number of HARQ process identifiers (IDs) to be used in transmission to or from the network device; and
receiving from the network device Downlink Control Information containing a HARQ process ID field having a length dependent on the number of HARQ process IDs.

23-26. (canceled)
